(19) United States
(12) Patent Application Publication
(10) Pub. No.: US 2015/0090411 A1
(43) Pub. Date: Apr. 2, 2015

(54) POLYCARBONATE LAMINATE WINDOW COVERS FOR RAPID DEPLOYMENT PROVIDING PROTECTION FROM FORCED-ENTRY AND BALLISTICS

(71) Applicants: Bayer MaterialScience LLC, Pittsburgh, PA (US); Southwest Aluminum & Glass Co., Inc,, Cuddy, PA (US)

(72) Inventors: Robert A. Pyles, Bethel Park, PA (US); James M. Lorenzo, Mars, PA (US); James Michael Ranalli, Venetia, PA (US)

(73) Assignees: Bayer MaterialScience LLC, Pittsburgh, PA (US); Southwest Aluminum & Glass Co., Inc,, Cuddy, PA (US)

(21) Appl. No.: 14/040,887

(22) Filed: Sep. 30, 2013

(51) Int. Cl. E06B 9/24

(52) U.S. Cl. CPC E06B 9/24
USPC 160/368.1

(57) ABSTRACT

The present invention provides a rapidly deployable window cover comprising a laminate panel comprising two or more layers of polycarbonate having layered therebetween one or more layers of a thermoplastic polyurethane, having a plurality of openings arranged around the periphery thereof and the plurality of openings extending through the panel; and a plurality of fasteners; wherein the plurality of openings are sized and shaped to receive the plurality of fasteners therethrough, and wherein the fasteners attach the panel to a structure in which the window is embedded such that the panel shields the window.

### FIELD OF THE INVENTION

The present invention relates in general to protective devices and more specifically to a transparent, polycarbonate laminate window cover for rapid deployment which provides protection from forced-entry and/or ballistics. The invention also relates to an adjustable frame to support the transparent forced-entry and ballistics-resistant window covers.

### BACKGROUND OF THE INVENTION

Due to recent events such as severe storms and terrorist attacks, there is a heightened interest in protecting structures or other sites from high velocity winds, from blasts due to projectiles, bombs or other explosive devices, and to provide physical security to building occupants. The windows in many standing structures were not designed with the intent of resisting high velocity winds and debris associated with natural events such as hurricanes or tornadoes, from forced-entry, or from unnatural events such as bomb blasts and/or high velocity projectiles and thus these windows may be particularly vulnerable to such events.

Bricking up windows, while effective, eliminates their functionality and may not be a rapidly deployable option. Boarding over windows has limited effectiveness and may contribute to the debris found in high velocity wind events. Also, boards over windows can be easily removed by perpetrators intent on breaching a building's physical security and offer little ballistics resistance.

A number of workers in the art have attempted, with varying degrees of success to address these issues.

U.S. Pat. No. 4,644,728 issued to Strauss et al. discloses a securing element for tensionally fastening additions like roof balustrades, exterior stairways, roofs, arbors, greenhouses, pergolas, advertising elements, poster walls, etc. that function as extensions or expansions, to structures, especially single-story structures erected with a kit of components. The securing element extends over the total length of one side of the main structure and has at least one fastening rail that extends over its own total length.

Frohlich et al., in U.S. Pat. No. 5,649,782 describes a transport anchor for transporting a heavy part, which anchor is embedded in the heavy part, includes a sleeve having an inner thread for receiving a load bearing member. The sleeve has a first section with an exterior end face positioned flush with the exterior surface of the heavy part. The sleeve has a second section with a receiving member for an anchoring element of the heavy part. A first plug with an outer thread is threaded into the inner thread of the sleeve and is moveable along the inner thread. The first plug has a plug end face facing outwardly relative to the heavy part. The load bearing member can frictionally engage the plug end face of the first plug. The load bearing member has a base body with an outer thread for cooperation with the inner thread of the sleeve. The base body has a first end for insertion into the sleeve, whereby the first end has an end face with an axial recess or an axial projection providing at least one matching contact surface for cooperation with the at least one axial contact surface at the plug.

U.S. Pat. No. 5,729,951 issued to Frohlich provides an anchoring device for the construction industry has an anchor rail that is C-shaped in cross-section and has a hollow interior so that the anchor rail has a back and legs connected to the back. The legs have angled free ends pointing toward one another and delimiting therebetween a longitudinal slot. The back has outwardly extending projections, each having an opening. Each opening has a double cone rim widening radially outwardly from the opening with radially outwardly diverging first and second conical surfaces. The double cone has an outer edge facing outwardly relative to the hollow interior. A plurality of anchors is connected. to the anchor rail, whereby each one of the anchors is received in one of the openings and attached thereto by plastic material deformation of the anchor rail and/or the anchor. The anchor has a cylindrical shaft with a head and a base opposite the head. The base of the shaft is positioned in the opening. In an initial state of the anchor, before attachment to the anchor rail, the shaft and the base have a cross-section that is smaller than the cross-section of the outer edge. The plastic material deformation of the base engages the double cone of the rim.

Fricker in U.S. Pat. No. 5,743,062 teaches an anchoring device for housing/building construction which has at least one anchoring member with a shaft and a first and a second end. The anchoring track to which the first end is form-fittingly connected has an inner and an outer surface. The second end has a fastening element for anchoring the device in a substrate such as concrete. At least the shaft is made of a pipe section. The anchoring track has an opening with an inner edge. The first end of the shaft penetrates the opening whereby the first end has at least one appendage formed at the free end penetrating through the opening, whereby the at least one appendage engages the opening from behind.

U.S. Pat. No. 5,960,606, issued to Dlubak, discloses a penetration resistant window which includes a sheet of window glass having a penetration resistant layer adhered thereto. A floating sheet made of hard material such as glass is adhered to the penetration resistant layer to provide abrasion resistance. The perimeter of the floating sheet is set back from the perimeter of the window glass. This set back is said to allow the window to be mounted in a window or door frame such that the perimeter of the window glass is secured to the frame, but the floating sheet is unconstrained by the frame. The penetration resistant window is said to be useful in architectural, residential and institutional applications for resisting debris penetration during hurricanes.

Kies in U.S. Pat. No. 5,992,123 describes a shear stud assembly which is formed at the construction site by assembling double-headed shear studs with a channel system which engages one-headed end of the shear studs. The shear stud assembly may be positioned in a slab, beam, or horizontal element around columns or vertical elements for reinforcement with the studs hanging downwardly from the channel system through the normally congested steel reinforcing. Several forms of channel system are disclosed, each of which permit the length of the assembly and the spacing of the studs to be adjusted to fit, and yet still remain within the design parameters, all without the use of skilled labor or special tools.

U.S. Pat. No. 6,237,306, issued to Dlubak provides a penetration resistant window including a sheet of window glass having a penetration resistant layer of ionoplast material adhered thereto. A floating sheet made of hard material such as glass is adhered to the penetration resistant layer to provide abrasion resistance. The perimeter of the floating sheet is set back from the perimeter of the window glass. This set back is said to allow the window to be mounted in a window or door frame such that the perimeters of the window glass and penetration resistant sheet are secured to the frame, but the floating sheet is unconstrained by the frame. The penetration resistant window is said to be useful in architectural, residential and institutional applications for resisting debris penetration during hurricanes.

Ting in U.S. Pat. No. 6,591,562 teaches a mullion connector connecting a mullion to a building structure, the mullion connector having a first flange and a second flange in a plane generally perpendicular to the first flange with a first flange having a first fastener opening capable of allowing relative motion of the mullion connector relative to the mullion in at least one direction and a second flange having an second fastener opening capable of allowing relative motion of the mullion connector relative to the building in at least two generally perpendicular directions. By placing the second flange on a generally horizontal surface such as a building floor, and loosely fastening the second flange through the second fastener opening to a building anchor, the first flange opening may be attached to the mullion allowing up and down and rotational motion while the second flange opening allows in & out and left to right motion while supporting the mullion. In addition, the pre-assembled mullion connector may also be used to hoist the mullion section and attached mullion connector to its assembly position on the face of the building.

U.S. Pat. No. 6,675,550, issued to Dlubak, discloses a penetration resistant window including a penetration resistant layer sandwiched between exterior and interior transparent sheets. The perimeter of the penetration resistant layer extends from the perimeters of the exterior and interior transparent sheets in a direction plane parallel with the planes of the transparent sheets. This extension is said to allow the laminated window sheets to be mounted in a window frame such that the perimeter of the penetration resistant layer is secured within a channel in the frame, preferably by an adhesive such as silicone glue. The penetration resistant window is said to be useful in architectural, residential and institutional applications for resisting debris penetration during hurricanes.

Lewkowitz, in U.S. Pat. No. 6,715,245, describes an impact resistant laminated glass and plastic pane for a hurricane resistant door light or similar opening. A glass pane is attached to a flexible plastic sheet that protrudes beyond the peripheral edge of the glass, preferably as an extension of the plastic laminate between outer glass laminate sheets. The pane body is mounted in a building structural part such as a door or wall, at an opening or at a recess, whereby the surface of the structural part extends up to a point adjacent to the pane. The flexible sheet that is attached to the pane, laps over the surface adjacent to the edge of the structural part around the pane. An elongated molding element that preferably frames the opening, is attached to the structural part so as to capture the flexible sheet between the molding element and the surface.

U.S. Pat. No. 6,854,219 issued to Kelly et al. provides a masonry lintel having a concealed spine which spans between piers to either side of an area to be arched and supports masonry bricks through means of horseshoe shaped plates which ride on the spine. The bricks are supported on the spine by stitching rods Which extend through apertures in the plates and the bricks. The plates are received in the grouting space between the bricks and, in the finished lintel, are grouted over to be completely hidden from view. Variations in the relative positions of the piers and the width of bricks used to construct the lintel are accommodated by adjustable supports between the spine and the piers which enable the position of the spine relative to the piers to be selectively adjusted. In the embodiments employing multiple generally parallel spines, these supports provide for adjustable spacing of the spines. Center supports for the spines are adjustable both vertically and horizontally to accommodate various structural design parameters.

Moreno, in U.S. Pat. No. 7,043,884, teaches a stone cladding system for building has a support frame formed by a plurality of spaced-apart upright mullions fixed to an exterior of a building by anchor bracket's with a number of horizontal cladding panel support rails mounted in vertically spaced apart rows on the mullions. Each stone cladding panel is mounted between at adjacent pair of vertically spaced-apart rails with a bottom of the cladding panel seated on the lowermost rail and a top of the cladding panel secured to the uppermost rail by a pair of retaining clips. A bottom of each stone cladding panel is fully supported along its length by the lowermost rail.

U.S. Pat. No. 7,469,511 issued to Wobber discloses a masonry coupling system for use in commercial and residential construction. In one aspect, the invention of Wobber includes an anchor channel mounted on a structure. The masonry coupling system further includes a key that interfaces the masonry veneer and interlocks with an anchor channel mounted on a structure.

Smith et al., in U.S. Pat. No. 7,537,836, describe a glazing element having a transparent laminate secured to a structural support, and a process for preparing the same. The laminate comprises at least one layer of glass having self-adhered directly to the layer of glass a layer of thermoplastic polymer having low haze, wherein the layer of thermoplastic polymer is attached to the structural support along the edges of the laminate.

U.S. Pat. No. 7,966,784 issued to Wobber provides a masonry anchoring system for use in commercial and residential construction. In one aspect, the invention includes a brick tie that interfaces the masonry veneer and interlocks with an anchor plate mounted on a structure.

Bolton et al., in U.S. Pat. No. 8,286,405, teach a glazing structure comprising one or more impact and fire resistant window layers comprising; A) a first glass or plastic layer; B) a fire resistant layer of a composition which essentially comprises about 10-40% by weight of tris (hydroxymethyl)aminoethane aminomethane, about 10 to 30% by weight of a member selected from the group consisting of ammonium phosphate, phosphoric acid, ammonium dibasic phosphate, ammonium dihydrogen phosphate, and triammonium phosphate; and about 35 to 65% by weight of a member selected from the group consisting of alkali metal borates, ammonium borate and its hydrate, sodium teraborate decahydrate, sodium borate, potassium borate, lithium borate, sodium meta borate tetrahydrate, boric acid, boric anhydride, boric oxides and ammonium borate, adjacent said first glass or plastic layer, and C) a second glass or plastic layer adjacent said fire resistant layer. The laminated architectural structures are said to include walls, floors, stairs, doors, bridges, and security windows for automobiles, bank tellers, ships, ocean platforms, locomotives, and the like.

U.S. Pat. No. 8,413,403 issued to Walker, III et al. provides a modular curtainwall system and a method for forming a curtainwall unit. The modular curtainwall system comprises a unit frame and a cassette. The cassette comprises a subframe and an interior portion. The stick unit frame and cassette may be assembled into a curtainwall unit at an offsite facility.

A need continues to exist in the art for rapid and easy to install devices to provide window protection from forced entry attempts and ballistics.

### SUMMARY OF THE INVENTION

Accordingly, the present invention provides an easy-to-install system that can protect the exterior windows from forced entry attacks. The system includes transparent panels which can be attached over existing windows of buildings as protective covers for conventional windows. Also provided is an inventive adjustable frame for mounting the window covers to permit rapid deployment of the system. Such rapid deployment may be necessary in times of strife or ahead of an impending storm such as a hurricane.

These and other advantages and benefits of the present invention will be apparent from the Detailed Description of the Invention herein below.

### BRIEF DESCRIPTION OF THE FIGURES

The present invention will now be described for purposes of illustration and not limitation in conjunction with the figures, wherein:

FIG. 1 shows a schematic depiction of the transparent window cover of the present invention;

FIG. 2 illustrates the inventive transparent window cover affixed to a window mounted in a masonry wall;

FIG. 3 depicts a top down view of the inventive transparent window cover showing mounting in front of a window;

FIG. 4 is a photograph of one view of the adjustable frame for mounting the inventive transparent window cover of the present invention;

FIG. 5 is a photograph of another view of the adjustable frame;

FIG. 6 is a photograph of another view of the adjustable frame.

### DETAILED DESCRIPTION OF THE INVENTION

The present invention will now be described for purposes of illustration and not limitation. Except in the operating examples, or where otherwise indicated, all numbers expressing quantities, percentages, and so forth in the specification are to be understood as being modified in all instances by the term “about.”

The present invention provides a rapidly deployable window cover comprising a laminate panel comprising two or more layers of polycarbonate having layered therebetween one or more layers of a thermoplastic polyurethane, having a plurality of openings arranged around the periphery thereof and the plurality of openings extending through the panel; and a plurality of fasteners; wherein the plurality of openings are sized and shaped to receive the plurality of fasteners therethrough, and wherein the fasteners attach the panel to a structure in which the window is embedded such that the panel shields the window.

Such transparent covers may be designed to be held in place by a framing system attached to the building, and surrounding the individual window openings. The framing system must compensate for the following: the coefficient of thermal expansion of polymeric materials, and associated expansion and contraction; the weight of the covers, some in excess of 750 lbs. (340 kg); different building architectures and materials of construction; and potential for fastener misalignments and lack of building wall flatness and squareness. Moreover, the installed panels and framing must be forced entry and ballistics certified. The present invention also provides an adjustable framing system that meets all the above criteria.

The polycarbonate panels useful in the inventive laminate are preferably transparent, but the present inventors contemplate situations where they may be translucent, or opaque. Suitable polycarbonate resins for preparing the panels useful in the laminates of the present invention are homopolycarbonates and copolycarbonates, both linear or branched resins and mixtures thereof.

The polycarbonates have a weight average molecular weight of preferably 10,000 to 200,000, more preferably 20,000 to 80,000 and their melt flow rate, per ASTM D-1238 at 300° C., is preferably 1 to 65 g/10 min., more preferably 2 to 35 g/10 min. They may be prepared, for example, by the known diphasic interface process from a carbonic acid derivative such as phosgene and dihydroxy compounds by polycondensation (See, German Offenlegungsschriften 2,063,050; 2,063,052; 1,570,703; 2,211,956; 2,211,957 and 2,248,817; French Patent 1,561,518; and the monograph by H. Schnell, “Chemistry and Physics of Polycarbonates”, Interscience Publishers, New York, N.Y., 1964).

In the present context, dihydroxy compounds suitable for the preparation of the polycarbonates of the invention conform to the structural formulae (1) or (2) below.

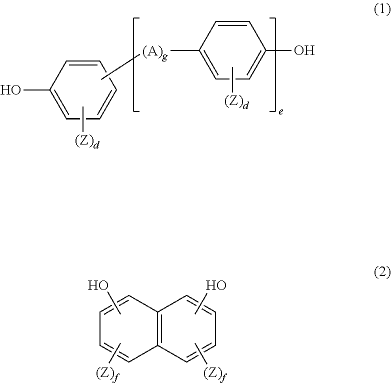

wherein
A denotes an alkylene group with 1 to 8 carbon atoms, an alkylidene group with 2 to 8 carbon atoms, a cycloalkylene group with 5 to 15 carbon atoms, a cycloalkylidene group with 5 to 15 carbon atoms, a carbonyl group, an oxygen atom, a sulfur atom, —SO— or —SO₂ or a radical conforming to (3)

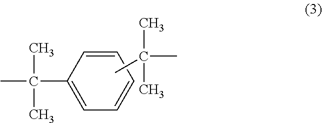

e and g both denote the number 0 to 1;
Z denotes F, Cl, Br or C₁-C₄-alkyl and if several Z radicals are substituents in one aryl radical, they may be identical or different from one another;
d denotes an integer of from 0 to 4; and
f denotes an integer of from 0 to 3.

Among the dihydroxy compounds useful in the practice of the invention are hydroquinone, resorcinol, bis-(hydroxyphenyl)-alkanes, bis-(10ydroxyl-phenyl)-ethers, bis-(hydroxyphenyl)-ketones, bis-(10ydroxyl-phenyl)-sulfoxides, bis-(hydroxyphenyl)-sulfides, bis-(hydroxyphenyl)-sulfones, and α,α-bis-(hydroxyphenyl)-diisopropylbenzenes, as well as their nuclear-alkylated compounds. These and further suitable aromatic dihydroxy compounds are described, for example, in U.S. Pat. Nos. 5,401,826, 5,105,004; 5,126,428; 5,109,076; 5,104,723; 5,086,157; 3,028,356; 2,999,835; 3,148,172; 2,991,273; 3,271,367; and 2,999,846, the contents of which are incorporated herein by reference.

Further examples of suitable bisphenols are 2,2-bis-(4-hydroxyphenyl)-propane (bisphenol A), 2,4-bis-(4-hydroxyphenyl)-2-methyl-butane, 1,1-bis-(4-hydroxyphenyl)-cyclohexane, α,α′(-bis-(4-hydroxy-phenyl)-p-diisopropylbenzene, 2,2-bis-(3-methyl-4-hydroxyphenyl)-propane, 2,2-bis-(3-chloro-4-hydroxyphenyl)-propane, 4,4′-dihydroxy-diphenyl, bis-(3,5-dimethyl-4-hydroxyphenyl)-methane, 2,2-bis-(3,5-dimethyl-4-hydroxyphenyl)-propane, bis(3,5-dimethyl-4-hydroxyphenyl)-sulfide, bis-(3,5-dimethyl-4-hydroxy-phenyl)-sulfoxide, bis-(3,5-dimethyl-4-hydroxyphenyl)-sulfone, dihydroxy-benzophenone, 2,4-bis-(3,5-dimethyl-4-hydroxyphenyl)-cyclohexane, α,α′-bis-(3,5-dimethyl-4-hydroxyphenyl)-p-diisopropyl-benzene and 4,4′-sulfonyl diphenol.

Examples of particularly preferred aromatic bisphenols are 2,2-bis-(4-hydroxyphenyl)-propane, 2,2-bis-(3,5-dimethyl-4-hydroxyphenyl)-propane, 1,1-bis-(4-hydroxyphenyl)-cyclohexane and 1,1-bis-(4-hydroxy-phenyl)-3,3,5-trimethylcyclohexane. The most preferred bisphenol is 2,2-bis-(4-hydroxyphenyl)-propane (bisphenol A).

The polycarbonates useful in producing the laminates of the invention may entail in their structure units derived from one or more of the suitable bisphenols.

Among the resins suitable in the practice of the invention are phenolphthalein-based polycarbonate, copolycarbonates and terpoly-carbonates such as are described in U.S. Pat. Nos. 3,036,036 and 4,210,741, both of which are incorporated by reference herein.

The polycarbonates useful in preparing the laminates of the invention may also be branched by condensing therein small quantities, e.g., 0.05 to 2.0 mol % (relative to the bisphenols) of polyhydroxyl compounds. Polycarbonates of this type have been described, for example, in German Offenlegungsschriften 1,570,533; 2,116,974 and 2,113,374; British Patents 885,442 and 1,079,821 and U.S. Pat. No. 3,544,514, which is incorporated herein by reference. The following are some examples of polyhydroxyl compounds which may be used for this purpose: phloroglucinol; 4,6-dimethyl-2,4,6-tri-(4-hydroxy-phenyl)-heptane; 1,3,5-tri-(4-hydroxyphenyl)-benzene; 1,1,1-tri-(4-hydroxyphenyl)-ethane; tri-(4-hydroxyphenyl)-phenyl-methane; 2,2-bis-[4,4-(4,4′-dihydroxydiphenyl)]-cyclohexyl-propane; 2,4-bis-(4-hydroxy-1-isopropylidine)-phenol; 2,6-bis-(2′-dihydroxy-5′-methylbenzyl)-4-methyl-phenol; 2,4-dihydroxybenzoic acid; 2-(4-hydroxy-phenyl)-2-(2,4-dihydroxy-phenyl)-propane and 1,4-bis-(4,4′-dihydroxytri-phenylmethyl)-benzene. Some of the other polyfunctional compounds are 2,4-dihydroxy-benzoic acid, trimesic acid, cyanuric chloride and 3,3-bis-(4-hydroxyphenyl)-2-oxo-2,3-dihydroindole.

In addition to the polycondensation process mentioned above, other processes for the preparation of the polycarbonates of the invention are polycondensation in a homogeneous phase and transesterification. The suitable processes are disclosed in U.S. Pat. Nos. 3,028,365; 2,999,846; 3,153,008; and 2,991,273 which are incorporated herein by reference.

The preferred process for the preparation of polycarbonates is the interfacial polycondensation process. Other methods of synthesis in forming the polycarbonates of the invention, such as disclosed in U.S. Pat. No, 3,912,688, incorporated herein by reference, may be used. Suitable polycarbonate resins are available in commerce, for instance, from Bayer MaterialScience under the MAKROLON trademark. The polycarbonate is preferably used in the form of panels, (sheets) or films in the inventive laminates. Suitable polycarbonate laminates are available under the HYGARD trademark.

Aliphatic thermoplastic polyurethanes are particularly preferred in the laminate of the present invention such as those prepared according to U.S. Pat. No. 6,518,389, the entire contents of which are incorporated herein by reference. Particularly preferred are thermoplastic polyurethane based on aliphatic chemistries to resist color changes from ultraviolet radiation exposure, especially ultraviolet radiation such as found in natural sunlight.

Thermoplastic polyurethane elastomers are well known to those skilled in the art. They are of commercial importance due to their combination of high-grade mechanical properties with the known advantages of cost-effective thermoplastic processability. A wide range of variation in their mechanical properties can be achieved by the use of different chemical synthesis components. A review of thermoplastic polyurethanes, their properties and applications is given in Kunststoffe [Plastics] 68 (1978), pages 819 to 825, and in Kautschuk, Gummi, Kunststoffe [Natural and Vulcanized Rubber and Plastics] 35 (1982), pages 568 to 584.

Thermoplastic polyurethanes are synthesized from linear polyols, mainly polyester diols or polyether diols, organic diisocyanates and short chain diols (chain extenders). Catalysts may be added to the reaction to speed up the reaction of the components.

The relative amounts of the components may be varied over a wide range of molar ratios in order to adjust the properties. Molar ratios of polyols to chain extenders from 1:1 to 1:12 have been reported. These result in products with hardness values ranging from 80 Shore A to 75 Shore D.

Thermoplastic polyurethanes can be produced either in stages (prepolymer method) or by the simultaneous reaction of all the components in one step (one shot). In the former, a prepolymer formed from the polyol and diisocyanate is first formed and then reacted with the chain extender. Thermoplastic polyurethanes may be produced continuously or batch-wise. The best-known industrial production processes are the so-called belt process and the extruder process.

Examples of the suitable polyols include difunctional polyether polyols, polyester polyols, and polycarbonate polyols. Small amounts of trifunctional polyols may be used, yet care must be taken to make certain that the thermoplasticity of the thermoplastic polyurethane remains substantially un-effected.

Suitable polyester polyols include those which are prepared by polymerizing ε-caprolactone using an initiator such as ethylene glycol, ethanolamine and the like. Further suitable examples are those prepared by esterification of polycarboxylic acids. The polycarboxylic acids may be aliphatic, cycloaliphatic, aromatic and/or heterocyclic and they may be substituted, e.g., by halogen atoms, and/or unsaturated. The following are mentioned as examples: succinic acid; adipic acid; suberic acid; azelaic acid; sebacic acid; phthalic acid; isophthalic acid; trimellitic acid; phthalic acid anhydride; tetrahydrophthalic acid anhydride; hexahydrophthalic acid anhydride; tetrachlorophthalic acid anhydride, endomethylene tetrahydrophthalic acid anhydride; glutaric acid anhydride; maleic acid; maleic acid anhydride; fumaric acid; dimeric and trimeric fatty acids such as oleic acid, which may be mixed with monomeric fatty acids; dimethyl terephthalates and bis-glycol terephthalate. Suitable polyhydric alcohols include, e.g., ethylene glycol; propylene glycol-(1,2) and -(1,3); butylene glycol-(1,4) and -(1,3); hexanediol-(1,6); octanediol-(1,8); neopentyl glycol; (1,4-bis-hydroxy-methylcyclohexane); 2-methyl-1,3-propanediol; 2,2,4-tri-methyl-1,3-pentanediol; triethylene glycol; tetraethylene glycol; polyethylene glycol; dipropylene glycol; polypropylene glycol; dibutylene glycol and polybutylene glycol, glycerine and trimethlyolpropane.

Suitable polyisocyanates for producing the thermoplastic polyurethanes useful in the laminates of the present invention may be, for example, organic aliphatic diisocyanates including, for example, 1,4-tetramethylene diisocyanate, 1,6-hexamethylene diisocyanate, 2,2,4-trimethyl-1,6-hexamethylene diisocyanate, 1,12-dodecamethylene diisocyanate, cyclohexane-1,3- and -1,4-diisocyanate, 1-isocyanato-2-isocyanatomethyl cyclopentane, 1-isocyanato-3-isocyanatomethyl-3,5,5-trimethyl-cyclohexane (isophorone diisocyanate or IPDI), bis-(4-isocyanatocyclohexyl)-methane, 2,4′-dicyclohexylmethane diisocyanate, 1,3- and 1,4-bis-(isocyanatomethyl)-cyclohexane, bis-(4-isocyanato-3-methylcyclohexyl)-methane, α,α,α′,α′-tetramethyl-1,3- and/or -1,4-xylylene diisocyanate, 1-isocyanato-1-methyl-4(3)-isocyanatomethyl cyclohexane, 2,4- and/or 2,6-hexahydrotoluylene diisocyanate, and mixtures thereof.

Preferred chain extenders with molecular weights of 62 to 500 include aliphatic diols containing 2 to 14 carbon atoms, such as ethanediol, 1,6-hexanediol, diethylene glycol, dipropylene glycol, and 1,4-butanediol in particular, for example. However, diesters of terephthalic acid with glycols containing 2 to 4 carbon atoms are also suitable, such as terephthalic acid-bis-ethylene glycol or -1,4-butanediol for example, or hydroxyalkyl ethers of hydroquinone, such as 1,4-di-(β-hydroxyethyl)-hydroquinone for example, or (cyclo)aliphatic diamines, such as isophorone diamine, 1,2- and 1,3-propylenediamine, N-methyl-propylenediamine-1,3 or N,N′-dimethyl-ethylenediamine, fur example, and aromatic diamines, such as toluene 2,4- and 2,6-diamines, 3,5-diethyltoluene 2,4- and/or 2,6-diamine, and primary ortho-, di-, tri- and/or tetraalkyl-substituted 4,4′-diaminodiphenylmethanes, for example. Mixtures of the aforementioned chain extenders may also be used. Optionally, triol chain extenders having a molecular weight of 62 to 500 may also be used. Moreover, customary monofunctional compounds may also be used in small amounts, e.g., as chain terminators or demolding agents. Alcohols such as octanol and stearyl alcohol or amines such as butylamine and stearylamine may be cited as examples.

To prepare the thermoplastic polyurethanes, the synthesis components may be reacted, optionally in the presence of catalysts, auxiliary agents and/or additives, in amounts such that the equivalent ratio of NCO groups to the sum of the groups which react with NCO, particularly the OH groups of the low molecular weight diols/triols and polyols, is 0.9:1.0 to 1.2:1.0, preferably 0.95:1.0 to 1.10:1.0.

Suitable catalysts include tertiary amines which are known in the art, such as triethylamine, dimethyl-cyclohexylamine, N-methylmorpholine, N,N′-dimethyl-piperazine, 2-(dimethyl-aminoethoxy)-ethanol, diazabicyclo-(2,2,2)-octane and the like, for example, as well as organic metal compounds in particular, such as titanic acid esters, iron compounds, tin compounds, e.g., tin diacetate, tin dioctoate, tin dilaurate or the dialkyltin salts of aliphatic carboxylic acids such as dibutyltin diacetate, dibutyltin dilaurate or the like. The preferred catalysts are organic metal compounds, particularly titanic acid esters and iron and/or tin compounds.

In addition to difunctional chain extenders, small quantities of up to about 5 mol. Percent, based on moles of the bifunctional chain extender used, of trifunctional or more than trifunctional chain extenders may also be used.

Trifunctional or more than trifunctional chain extenders of the type in question are, for example, glycerol, trimethylolpropane, hexanetriol, pentaerythritol and triethanolamine.

Suitable thermoplastic polyurethanes are available in commerce, for example, from Bayer MaterialScience under the TEXIN trademark. The thermoplastic polyurethanes are preferably used in the present invention in the form of films or sheets.

The thickness of the polycarbonate laminates of the present invention is preferably 0.5 inches (1.2 cm) to 4 inches (10.2 cm), more preferably 1 inch (2.54 cm) to 2 inches (5.1 cm). The thickness of the laminates of the present invention may be in an amount ranging between any combination of these values, inclusive of the recited values. Although these polycarbonate laminates have some inherent resistance to ballistics, ballistics resistance may be significantly enhanced by reinforcing the polycarbonate laminates with layers of glass.

### EXAMPLES

The present invention is further illustrated, but is not to be limited, by the following examples.

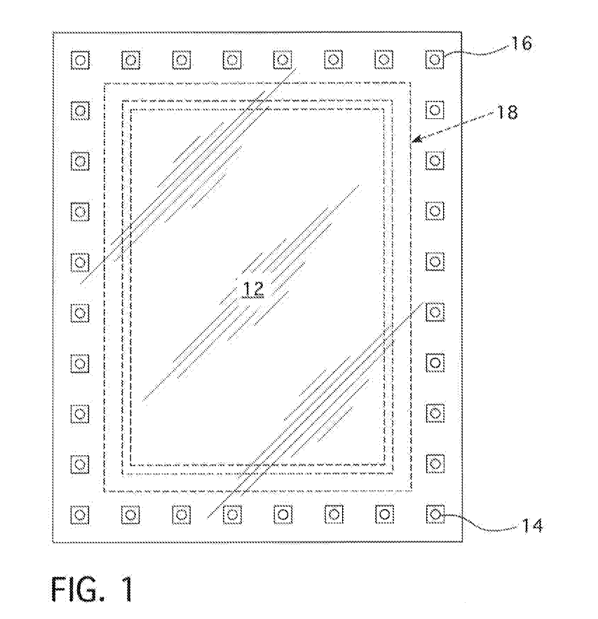

FIG. 1 shows a schematic depiction of the transparent window cover 12 of the present invention covering window 18. Laminate 12 and complementary support assembly bolt-hole positions 14 are shown and washers 16 are provided on the front and back sides of the panel 12.

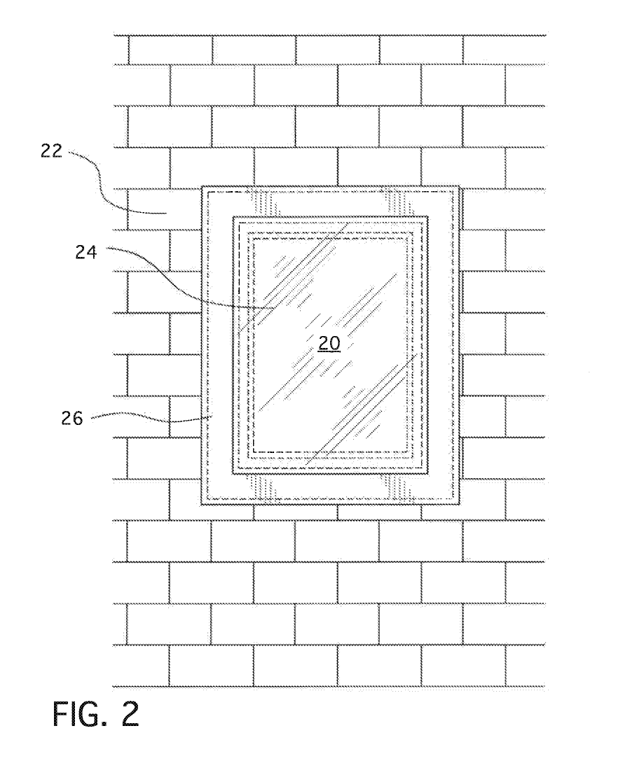

FIG. 2 illustrates an elevation view of the inventive transparent window cover 24 affixed to a window 20 mounted in a masonry wall 22 optionally including a metal cover 26.

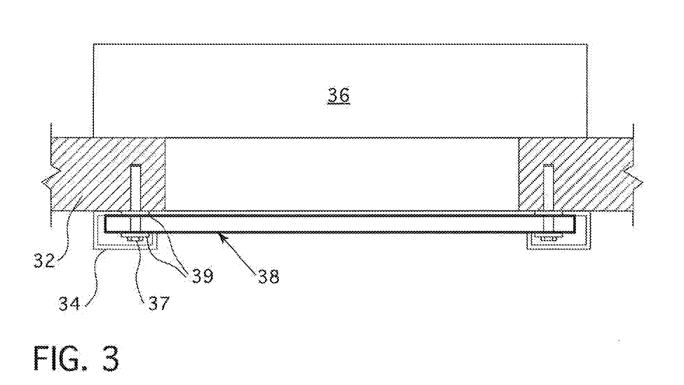

FIG. 3 depicts a top down or plan view of the inventive transparent window cover 38 showing the cover being mounted in front of a window 36. The metal support frame 34 is securely anchored to the masonry wall 32 using adhesive anchors 37 (such as HIT-HY 150, commercially available from Hilti Corporation). The depicted washers 39 permit the laminated panel 38 to expand and contract with fulgurations in the temperature of the environment. The anodized aluminum covers 34 offer a partial seal against rain incursion as well as enhanced aesthetics by hiding the bolts from view.

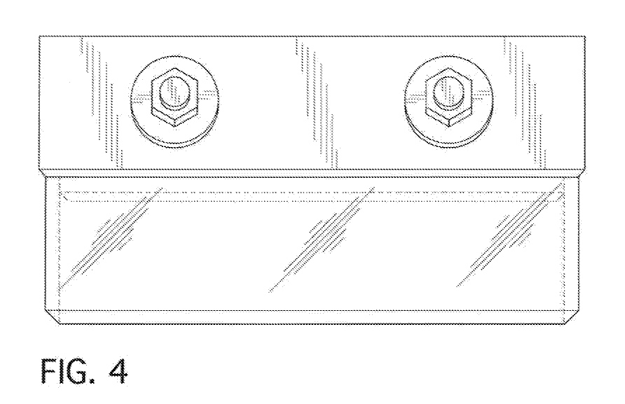

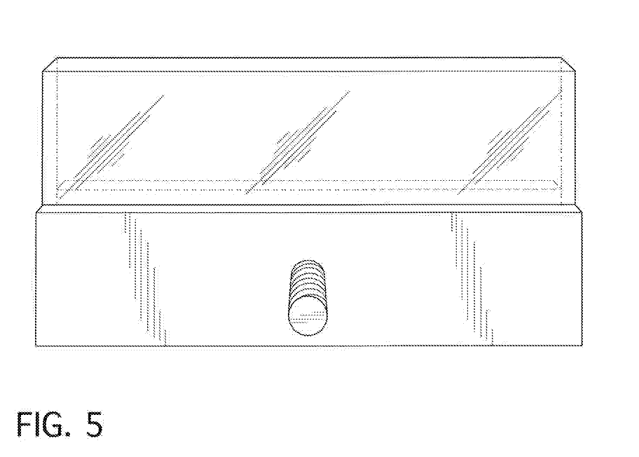

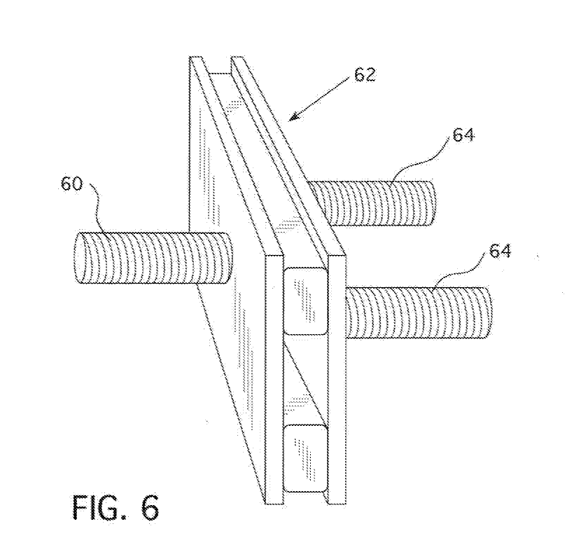

Referencing FIGS. 4-6, the steel support assembly is shown in profile in FIG. 6. The stud 60 protruding from the support assembly 62 to the left connects the support assembly to the building wall. Once the support assembly is connected to the building wall, the two threaded studs 64 protruding from the support assembly to the right are used to align and bolt the laminated panel, containing pre-made holes, to the support assembly. The laminated panel is further supported with the aid of an exterior-facing pressure plate bolted with the laminated panel to the frame as shown in FIG. 4. FIG. 5 shows the support assembly from the perspective of the building wall. The support assembly stud in the foreground of FIG. 5 is normally embedded in the building wall. Note that the support assembly studs float in a channel of the frame created by welding two parallel bars to the frame members. The extent to which the studs can float in the channel are limited by the dimensions of the holes through which the studs protrude. This configuration thus aids alignment and installation of the support assembly studs to the complementary holes in the building and laminated panel,.

In one embodiment, the inventive framing system may comprise parallel pieces of 3-inch (7.62 cm) wide and ¼ inch (6.35 mm) thick steel, sufficient in length to frame the existing window; two pieces of ¾ inch (1.9 cm) wide by ½ inch (1.27 cm) thick steel bar, inset ¼ inch (6.35 mm) from opposite edges of the 3-inch (7.62 cm) wide steel, also sufficient in length to frame the existing window and welded parallel to the 3-inch (7.62 cm) wide pieces. The objective of this configuration is to create a 1⅛ inch (2.86 cm) gap between the two steel bars into which the heads of hex-head bolts are inserted.

Into one face of the 3-inch (7.62 cm) wide steel piece is cut elliptical-shaped holes, sized. to permit the bolts to protrude and slide the length of the elliptical-shaped hole. In the 3-inch (7.62 cm) wide steel on the opposite face of the frame is a circular hole into which another hex-head bolt is inserted. The hex-head portion of the bolts is inserted in the 1⅛-inch (2.86 cm) gap. Both the parallel 3-inch (7.62 cm) wide steel pieces are then welded together to keep the boil heads in the 1⅛-inch (2.86 cm) wide gap.

The number of protruding bolts depends on the robustness of the frame design. The bolt protruding from the circular hole will be the frame attachment to the building. These bolts can be secured to the face of the building using several means, including drilling holes in the building, inserting the bolt and then using an adhesive such as epoxy to keep the frame attached to the building, or alternatively, drilling a hole entirely through the building wall, inserting a threaded bolt with sufficient length to go completely through the wall and held in place by bolting to a pressure plate on the interior of the building. The bolts protruding through the elliptical holes in the opposite side of the frame are used to attach the transparent panels to the frame. The elliptical holes will allow the bolts to align with the complementary holes in the transparent panel, even if they should be misaligned. The bolts may preferably be modified so they are difficult to remove, and the forced-entry certification can be met.

Various aspects of the subject matter described herein are set out in the following numbered clauses in any combination thereof:

1. A rapidly deployable window cover comprising a laminate panel comprising two or more layers of polycarbonate having layered therebetween one or more layers of a thermoplastic polyurethane, having a plurality of openings arranged around the periphery thereof and the plurality of openings extending through the panel; and a plurality of fasteners; wherein the plurality of openings are sized and shaped to receive the plurality of fasteners therethrough, and wherein the fasteners attach the panel to a structure in which the window is embedded such that the panel shields the window.

2. The rapidly deployable window cover according to Claim 1, wherein the panel is transparent.

3. The rapidly deployable window cover according to Claim 1, wherein the panel is translucent.

4. The rapidly deployable window cover according to Claim 1, wherein the panel is opaque.

5. The rapidly deployable window cover according to Claim 1, wherein the thermoplastic polyurethane is based on aliphatic chemistries to resist color changes from ultraviolet radiation exposure.

6. The rapidly deployable window cover according to Claim 1, wherein the fasteners are selected from the group consisting of bolts, screws, rods, rivets and pins.

7. The rapidly deployable window cover according to Claim 1 wherein the laminate includes one or more glass layers.

8. The rapidly deployable window cover according to Claim 1 further including a metal frame surrounding the window.

Also, it is contemplated that any optional feature of the inventive variations described may be set forth and claimed independently, or in combination with any one or more of the features described herein. Reference to a singular item, includes the possibility that there are plural of the same items present. More specifically, as used herein and in the appended claims, the singular forms “a,” “an,” “said,” and “the” include plural referents unless the specifically stated otherwise. In other words, use of the articles allow for “at least one” of the subject item in the description above as well as the claims below. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation. Without the use of such exclusive terminology, the term “comprising” in the claims shall allow for the inclusion of any additional element—irrespective of whether a given number of elements are enumerated in the claim, or the addition of a feature could be regarded as transforming the nature of an element set forth in the claims. Stated otherwise, unless specifically defined herein, all technical and scientific terms used herein are to be given as broad a commonly understood meaning as possible while maintaining claim validity.

The foregoing examples of the present invention are offered for the purpose of illustration and not limitation. It will be apparent to those skilled in the art that the embodiments described herein may be modified or revised in various ways without departing from the spirit and scope of the invention. The scope of the invention is to be measured by the appended claims.

What is claimed is:

1. A rapidly deployable window cover comprising:
a laminate panel comprising two or more layers of polycarbonate having layered therebetween one or more layers of a thermoplastic polyurethane, having a plurality of openings arranged around the periphery thereof and the plurality of openings extending through the panel; and
a plurality of fasteners;
wherein the plurality of openings are sized and shaped to receive the plurality of fasteners therethrough, and wherein the fasteners attach the panel to a structure in which the window is embedded such that the panel shields the window.

2. The rapidly deployable window cover according to claim 1, wherein the panel is transparent.

3. The rapidly deployable window cover according to claim 1, wherein the panel is translucent.

4. The rapidly deployable window cover according to claim 1, wherein the panel is opaque.

5. The rapidly deployable window cover according to claim 1, wherein the thermoplastic polyurethane is based on aliphatic chemistries to resist color changes from ultraviolet radiation exposure.

6. The rapidly deployable window cover according to claim 1, wherein the fasteners are selected from the group consisting of bolts, screws, rods, rivets and pins.

7. The rapidly deployable window cover according to claim 1 wherein the laminate includes one or more glass layers.

8. The rapidly deployable window cover according to claim 1 further including a metal frame surrounding the window.
